(19) United States
(12) Patent Application Publication
(10) Pub. No.: US 2002/0162117 A1
(43) Pub. Date: Oct. 31, 2002

(54) System and method for broadcast-synchronized interactive content interrelated to broadcast content

(76) Inventors: Martin Pearson, Venice, CA (US); Nicole M. Corbin, Pasadena, CA (US)

Correspondence Address: Ted R. Rittmaster, FOLEY & LARDNER, 2029 Century Park East - Suite 3500, Los Angeles, CA, 90067-3021, US

(21) Appl. No.: 09/843,397

(22) Filed: Apr. 26, 2001

(51) Int. Cl. H04N 5/445; G06F 3/00; G06F 13/00; H04N 7/173; H04N 7/16

(52) U.S. Cl. 725/109; 725/112; 725/37; 725/135

(57) ABSTRACT

A system and method for synchronizing interactive content with particular scenes in a television program for use with an interactive television system. An HTML page displays both the television program and interactive functionality which allows the presentation to the user of specific information, such as facts and observations, which is synchronized to and interrelated with particular content within the television program. The system and method enables the user to enter responses to program-related questions and can be utilized for implementing a rewards-based user-interactive viewing experience. The system and method also enables an advertiser to synchronize advertisements to particular scenes within a television program, thus allowing the advertiser to tie products to the program the user is viewing.

### RELATED APPLICATIONS

The present application relates to a co-pending U.S. utility patent application entitled “System and Method for Managing Interactive Programming and Advertisements in Interactive Broadcast Systems,” Attorney Docket No. 041892.0211, filed Apr. 26, 2001. The content of that application is incorporated by reference herein.

### BACKGROUND OF THE INVENTION

1. Field of the Invention

Embodiments of the present invention relate to systems and methods for providing interactive media events such as broadcast programs (for example, television programs), and in example embodiments, to systems and methods for providing interactive broadcast programs which provide information to the user, the information being synchronized to particular content presently being viewed on the interactive broadcast program. Further example embodiments relate to providing quiz questions and quiz games to viewers of the interactive broadcast program, the quiz questions being synchronized to particular content presently being viewed in the interactive broadcast program.

2. Description of Related Art

The emerging technology of interactive television holds a promise of allowing a television set to serve as a two-way information distribution mechanism. Proposed features of interactive television accommodate a variety of marketing, entertainment, and educational capabilities such as allowing a user to order an advertised product or service, compete against contestants in a game show, or request specialized information regarding a televised program. Typically, the interactive functionality is controlled by a “set-top” decoder box (“set-top box” or “STB”) which executes an interactive program written for the television broadcast. The interactive functionality is often displayed upon the television's screen and may include icons or menus to allow a user to make selections via the television's remote control or a keyboard.

The program interactivity may be optional. Thus, a user who chooses not to interact or who does not have interactive functionality included with the user's television should not suffer any degradation or interruption in program content. In order to provide this option to users, a transparent method of incorporating interactive content into the broadcast stream that carries the program is employed. In the present disclosure, “broadcast stream” refers to the broadcast signal, whether analog or digital, regardless of the method of transmission of that signal, i.e. by antenna, satellite, cable, or any other method of analog or digital signal transmission.

One method of transparently incorporating interactive content into the broadcast stream is the insertion of triggers into the broadcast stream for a particular program. Devices and methods for inserting triggers into a broadcast stream are well known in the art. Program content in which such triggers have been inserted is sometimes referred to as enhanced program content or as an enhanced television program or video signal. FIG. 1 shows a simplified view of enhanced program content 102 which contains triggers 106 within the content. Break 104 represents an interval between portions of enhanced program content 102 where advertising from arbitrary sources may be inserted, for example, a commercial break.

Triggers may be used to alert a STB that interactive content is available. The trigger may contain information about available enhanced content as well as the location of the enhanced content. A trigger may also contain user-perceptible text that is displayed on the screen, for example, at the bottom of the screen, which may prompt the user to perform some action or choose amongst a plurality of options. Thus, a user with a television that has interactive functionality may be prompted at the beginning of an enhanced television program to choose between interactive and passive (non-interactive) viewing of the enhanced television program.

If the user chooses passive viewing, any further triggers contained in the enhanced television program may be ignored by the STB and the user will view the program in a conventional way. However, if the user chooses the interactive option, then further triggers embedded in the enhanced television program at predetermined times in the enhanced television program may cause the presentation of interactive content to the user.

Triggers may be inserted into the broadcast stream at various points along the broadcast path. FIG. 2 shows a typical broadcast path 200 for program content. Triggers may be inserted into the broadcast stream before broadcast of the content by the broadcast station 202. Thus, these triggers would be part of the broadcast stream received by video delivery means such as cable head ends 204 and 206 and further distributed to homes 208 and 210 and their respective televisions 212 and 214. Televisions 212 and 214 are provided with interactive functionality by their associated STBs 216 and 218, respectively. Other video delivery means besides, or in addition to cable head ends 204 and 206, may be used, including, but not limited to, satellite or broadcast facilities.

However, triggers may also be inserted at cable head ends 204 and 206, either for the first time or in addition to, or in place of, triggers previously inserted before broadcast from broadcast station 202. Thus, triggers inserted at cable head end 204 may trigger content specifically targeted at homes for which it provides cable service, such as home 208, while triggers inserted at cable head end 206 may trigger content specifically targeted at homes for which it provides cable service, such as home 210. Thus, advertisements or other content may be targeted to specific regions or even specific neighborhoods. This allows for very specific targeted marketing techniques to be applied to the viewing public.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a television screen. Such closed caption decoders process the text data separately from the video signal.

The Advanced Television Enhancement Forum (ATVEF) has defined protocols for Hypertext Markup Language (HTML)-based enhanced television. These protocols allow the delivery of enhanced television programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced television program. ATVEF triggers comprise a Universal Resource Locator (URL) which provides an Internet address from which interactive content may be downloaded.

One example of the use of interactive television was an interactive version of the Jeopardy game show. Viewers who had interactive functionality associated with their television sets were able to play along with the in-studio contestants. Thus, viewers could compete from their homes in a fashion similar to the in-studio contestants. The viewers could interactively activate their buzzers, select categories and dollar levels within categories, and select “daily double” dollar wagers by, for example, selecting certain operators on a remote control or keyboard associated with the interactive functionality. Thus, the viewers experience of the game show may have been elevated from that of passive enjoyment to a more exhilarating experience that may have enhanced the viewer's enjoyment of Jeopardy and perhaps enticed the viewer to view Jeopardy again, leading to additional viewers for Jeopardy and additional revenue from sponsors.

The advantages of interactive television in the context of a game show like Jeopardy stem from the fact that a game show is participatory by definition. While viewing a game show without the benefit of interactive functionality, the viewer still often times finds himself yelling answers or price estimates to the in-studio contestants. Thus, the advantage of adding an actual interactive functionality to the game show that allows the viewer to not merely yell out answers or prices, but actually participate by inputting the answers or prices, is apparent. It is likely to result in an increased number of viewers and, consequently, advertising revenue.

However, it is not at all apparent how to stimulate additional interest through the provision of interactive functionality in television programs other than game shows. Television programs such as situation comedies, soap-operas, or adventure shows tend to be viewed in a much more passive fashion. Thus, although there may be items on the television screen at a particular time in the broadcast, such as clothing, cars, or places, that would interest or stimulate a particular viewer, or motivate the particular viewer to perform some action, the non-interactive presentation of those items on the screen often results in the viewer not even noticing the items, except perhaps on a sub-conscious level.

### SUMMARY OF THE DISCLOSURE

Therefore, it is an advantage of embodiments of the present invention to address the need for stimulating additional interest in broadcast programs, including but not limited to broadcast television programs, by providing interactive functionality. Interactive functionality may be synchronized to a broadcast program in such a way that the interactive content is interrelated to what is being viewed on-screen at the moment when the interactive content appears on-screen.

According to one embodiment, an enhanced broadcast program provides to a user an option to view the program interactively such that interactive content, such as specific facts and information (such as trivia facts) about people, places, products, or other things, that are synchronized to and interrelated with content within the program currently displayed to the user on-screen, is presented to the user. During this synchronized interactive viewing, the user is presented with an HTML page with user-selectable operators, such as buttons, similar to a page seen on the World Wide Web. The enhanced broadcast program is visible to the user on a portion of the HTML page on the television screen. Triggers inserted into the enhanced broadcast program activate interactive functionality which is part of the HTML page.

In example embodiments the user is able to input responses to displayed questions that are synchronized to and interrelated with a particular moment (segment) in the program. The user may be awarded points or other rewards for correct answers. In addition, points may be awarded to a user based on viewing a particular portion of a program or for selecting particular interactive content to view. These points may be the basis of a ranking system that is related to a particular program or may be redeemable for merchandise or other rewards.

According to a further embodiment, advertisers may advantageously synchronize advertisements to a particular segment in a program where an advertiser's product is seen or heard on-screen. Thus, the advertiser is offered a unique opportunity to tie products to the program the user is viewing.

These and other advantages are accomplished according to systems and methods for broadcast-synchronized interactive content interrelated to program content.

### BRIEF DESCRIPTION OF THE DRAWINGS

Embodiments of the present invention are illustrated by way of example, and not by way of limitation, in the figures of the accompanying drawings and in which:

FIG. 1 illustrates a simplified view of triggers inserted into enhanced program content;

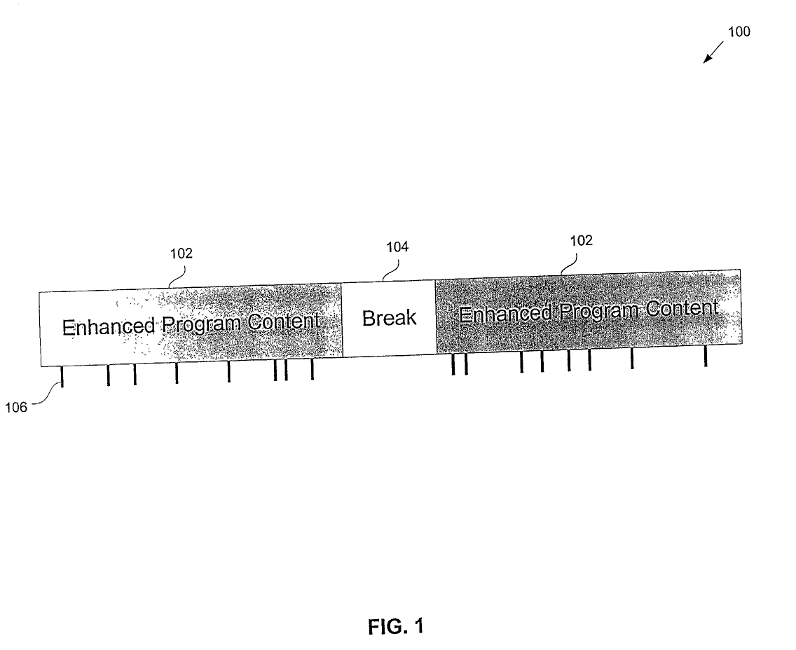

FIG. 2 is a generalized schematic representation of a broadcast path for program content in which embodiments of the present invention may operate;

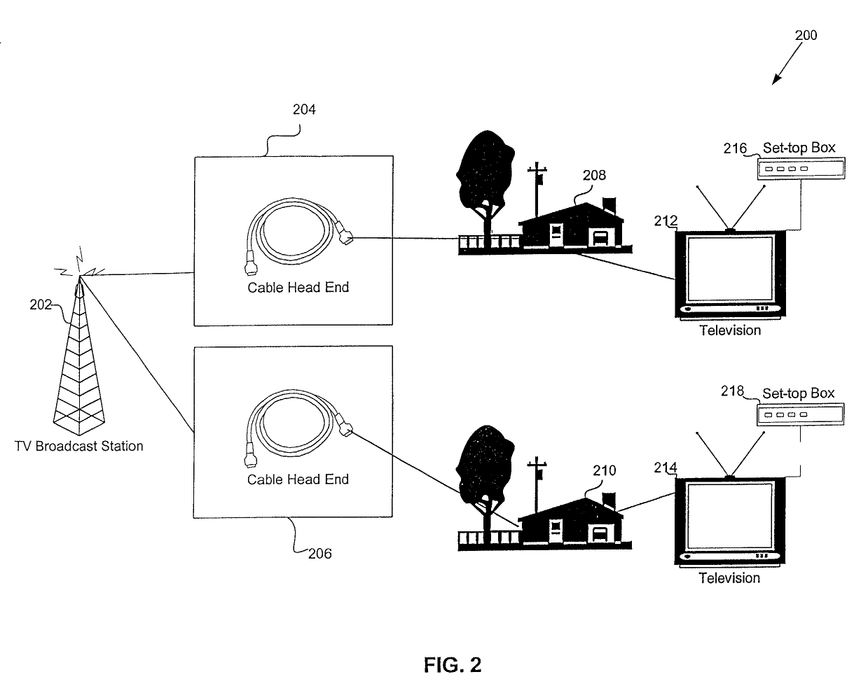

FIG. 3 is a generalized schematic representation of a system hardware environment in which embodiments of the present invention may operate;

FIG. 4 illustrates a conventional, non-interactive television screen;

FIG. 5 illustrates communication between a set-top box and a network server according to an embodiment of the present invention;

FIG. 6 illustrates a prompt on a television screen according to an embodiment of the present invention;

FIG. 7 illustrates an interactive facts and information screen according to an embodiment of the present invention;

FIG. 8 illustrates an interactive facts and information screen according to an embodiment of the present invention;

FIG. 9 is a representative example of a question and answer screen according to an embodiment of the present invention;

FIG. 10 is a representative example of a “true or false” question and answer screen according to an embodiment of the present invention;

FIG. 11 is a representative example of a fan club facts and information screen according to an embodiment of the present invention.

### DETAILED DESCRIPTION OF PREFERRED EMBODIMENTS

Embodiments of the present invention relate to systems and methods for providing interactive content which is synchronized to particular segments of media events, including, but not limited to, enhanced broadcasts (“programs”), and in example embodiments, to systems and methods for providing interactive content which provides the user with an enhanced viewing experience due to the interrelationship of the interactive content to what is currently being shown on-screen at the particular moment the interactive content appears on-screen.

Systems and methods according to example embodiments of the present invention may be employed to provide interactive content which comprises triggers that are synchronized to the enhanced broadcast program in such a way that the interactive content is interrelated to something currently being viewed on-screen, including, but not limited to, persons, places, and products.

In one embodiment, facts and information related to what is currently on-screen, including, but not limited to, people, places, and products, is displayed to the user in order to provide the user with an enhanced viewing experience.

In addition, further embodiments are described in which the user interacts with the interactive content by conducting activities including, but not limited to, inputting answers to questions about people, places, things, and events. The questions may be related to content currently on screen or to other subjects, including, but not limited to, facts about the production of the program currently being shown, character insights, details about the cast and crew, and little known facts related to the program.

In further embodiments, the interactive content may comprise advertising material interrelated to items including, but not limited to, clothing, automobiles, appliances, foods, beverages, jewelry, sporting goods, and makeup, that are currently being shown on-screen as part of the enhanced broadcast program.

In one embodiment, the interactive content is presented to the user in the form of an HTML page displayed on-screen which may include JavaScript to implement interactive functionality within the HTML page. Although the present disclosure describes interactive content which is implemented in particular software languages such as HTML and JavaScript, the systems and methods described in the present disclosure may be implemented in any suitable software language or protocol for displaying interactive content, including, but not limited to, DHTML, Java, VRML, and CSS, and in firmware, hardware comprising hardwired logic, or any combination thereof.

Systems and methods according to example embodiments of the invention may be employed in any signaling system for providing interactive content. For purposes of simplifying the present disclosure, embodiments are described herein with reference to an analog interactive television system that employs an ATVEF standard for delivery of interactive content, including the use of ATVEF triggers. However, any suitable analog or digital signaling system may be used, in combination with any suitable delivery method, for providing enhanced media events that incorporate interactive functionality.

Similarly, embodiments are described herein with reference to enhanced television programs. However, the systems and methods described in the present disclosure may be implemented in any media that may be enhanced through the use of events including, but not limited to, triggers, that are synchronized to user-perceptible segments in the media.

Furthermore, although embodiments described in the present disclosure are implemented using a television in association with a STB, any other suitable interactive enabling device with a storage device for storing content and/or a play or display mechanism for playing or displaying content to the user may be used to provide interactive functionality, including, but not limited to, a personal computer, personal digital assistants (PDAs), or mobile telephone devices.

### System Hardware Environment

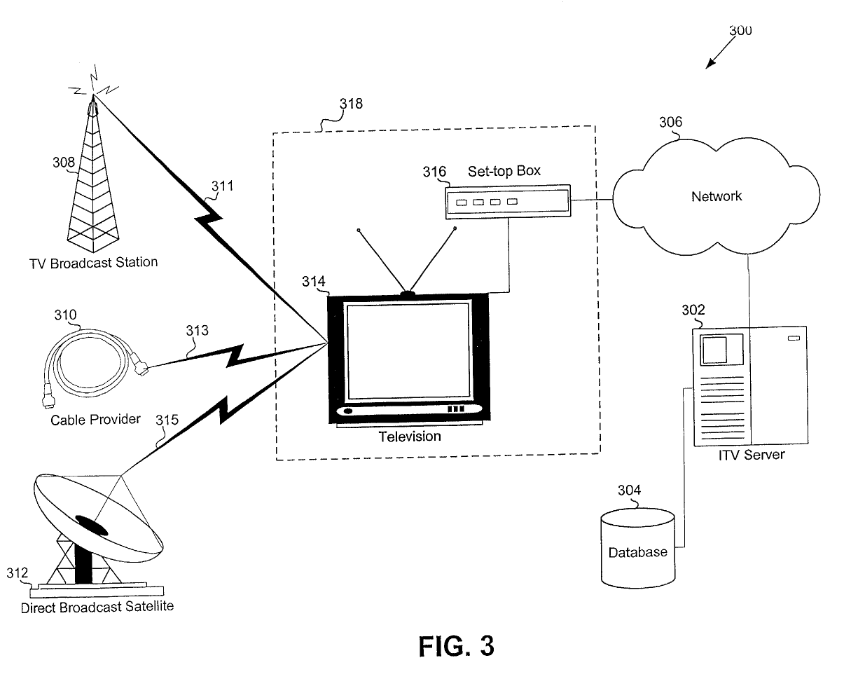

An example system hardware environment employed with embodiments of the present invention is shown in FIG. 3. FIG. 3 shows a system configuration for an interactive TV (ITV) system 300. An ITV system is shown as an example embodiment of the present invention. However, any signaling system for providing interactive content is within the teachings of the present invention. An ITV system comprises the following components: ITV server 302, database 304, network 306, broadcast station 308, cable provider 310, satellite provider 312, television 314, and STB 316. In the embodiment described in relation to FIG. 3, an ITV functionality is provided, on the user end, by an interactive enabling system composed of television 314 and STB 316. However, any other suitable interactive enabling system or device having a storage device for storing content and/or a play or display mechanism for playing or displaying content to the user may be used, including, but not limited to, a personal computer, personal digital assistants (PDAs), or mobile telephone devices. STB 316 is typically responsive to a user's remote control and provides an interactive display output to the user's television. Although the television 314 and the STB 316 that make up the ITV in the present embodiment are shown as distinct units, it is understood that in other embodiments the functionalities of television 314 and STB 316 may be combined and incorporated into one ITV unit. Hereinafter, the interactive enabling system on the user end (for example, the combination of television 314 and STB 316) will be referred to as ITV 318.

The ITV 318 may comprise a modem, cable modem, Digital Subscriber Line (DSL), or other suitable means of connecting to a network 306. In one example embodiment, network 306 is the Internet and provides ITV 318 with access to the World Wide Web and to a plurality of sources of interactive content. In other embodiments, other communication networks may be used, including, but not limited to, private networks (for example, a network provided by an Internet Service Provider (ISP) for its subscribers), and direct connections (such as a directly wired set of stations in a limited area such as a hotel, office building, educational facility or the like). The ITV 318 may also comprise a local memory for storing programs, interactive content, and data.

An ITV server 302 may provide one source of the interactive content to the ITV 318. In signaling systems other than ITV, ITV server 302 may be any type of server for providing interactive content. The ITV server 302 may comprise one or more processing units, storage systems and many subsystems such as a database subsystem, application processing subsystem, control subsystem and a network 306 access subsystem. ITV server 302 may include or operate with one or more memory devices containing data, such as database 304. Data stored in database 304 may include interactive content including, but not limited to, a plurality of interactive programs, data for creating or generating text, images, designs or other indicia that compose Web pages, as well as user information, historical activities of users, and other data used by the ITV system 300. In other embodiments, more than one ITV server may be employed, for example, for load distribution or for redundancy in the event that ITV server 302 fails.

In one embodiment, the ITV system 300 allows an enhanced television program that can be viewed on any conventional television set as a normal program to be combined with interactive content. As discussed above, in the present embodiment the interactive functionality is provided by STB 316. The STB 316 may incorporate software, hardware, firmware, or combinations thereof that cause interactive content to load within the enhanced television program. This loading software may be activated by an access code contained within a trigger that has been inserted in the enhanced television program, as discussed above. The interactive content that is loaded by the loading software may be contained in the ITV 318 local memory or may be downloaded from an ITV server 302 memory device such as database 304.

In one embodiment, the enhanced television program is provided to television 314 by television broadcast station 308 (as shown by reference numeral 311), cable provider 310 (as shown by reference numeral 313), direct broadcast satellite 312 (as shown by reference numeral 315), or other transmission means. In the embodiment shown in FIG. 3, television 314 is an analog television and thus suitable analog means of signal transmission have been shown. In another embodiment, television 314 may be a digital television and any suitable digital transmission means may be used to deliver the digital signals.

At some point while viewing the normal program, the user may be prompted as to whether the user wishes to begin to interact with the program. In one embodiment, this prompt would be at the beginning of the normal program and would be initiated by a trigger that was synchronized with the beginning of the program. In other embodiments, the prompt may be provided after a selected time interval after the beginning of the normal program.

As discussed above, in one embodiment the trigger comprises a URL. The URL will cause the ITV 318 to access the particular Internet address associated with that URL. In the present embodiment, the URL will cause ITV 318 to access ITV server 302. ITV server 302 may be programmed to respond to the access code contained within the prompting trigger by downloading the content necessary to display an interactive screen prompt to the user that will prompt the user about interaction with the program. This screen prompt may present to the user user-selectable choices as to whether the user wishes to begin to interact with the normal program.

If the user chooses not to interact with the normal program, the user will continue to view the program as before. If the user chooses to interact with the program, further triggers embedded in the enhanced television program at designated times may contain access codes which cause new interactive content of arbitrary functionality to be downloaded from ITV server 302 and displayed to the user on television 314. Thus, the ITV system 300 shown in FIG. 3 allows a user of ITV 318 to receive an enhanced television program from one source (television broadcast station 308, cable provider 310, direct broadcast satellite 312) and interactive content from another source (ITV server 302). The interactive content is then incorporated into the enhanced television program by the ITV 318, thereby allowing the user to experience a fully functional interactive program.

System and device functions and processes described herein may be implemented with machine-executable instructions. Software comprising these instructions may be used to program and cause general-purpose or special-purpose processors (the ITV server processor or processors and the processor or processors within the STB or other interactive enabling device, depending upon the function or process being performed) to perform the functions and processes described herein. Alternatively, such functions and processes may be implemented by firmware, hardware comprising hardwired logic, or by any combination thereof.

### System Operation

A system and method for receiving interactive content synchronized to interrelated segments of enhanced television program content will now be described in relation to FIGS. 3 through 8. In one example embodiment of the present invention, when a user turns on television 314, shown in FIG. 3, the user will select particular content to view from a particular source. In the present example, it will be assumed that the user chooses to view an adventure show which is broadcast from a particular television broadcast station, for example, broadcast station 308 in FIG. 3.

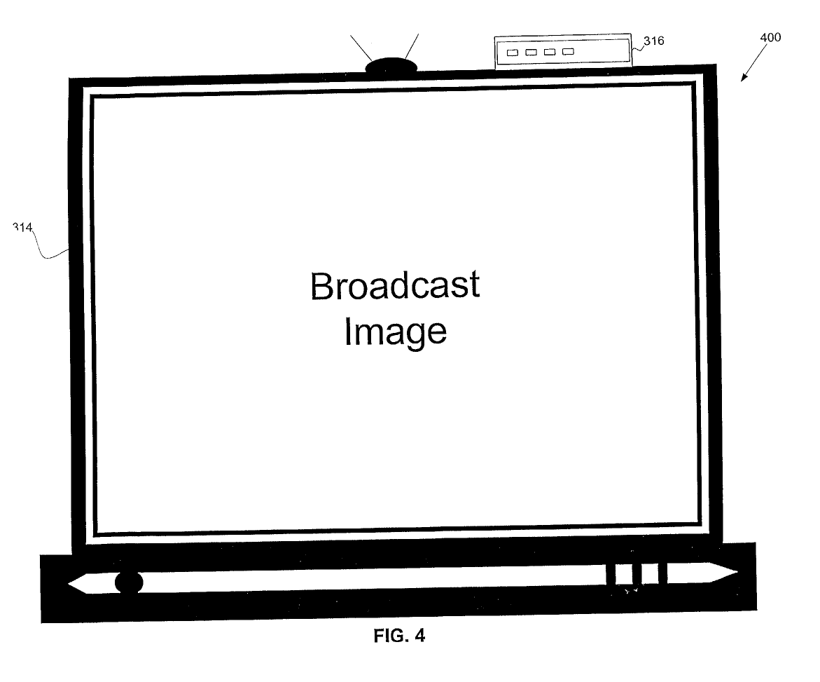

Thus, the user turns on television 314 and selects the channel corresponding to the desired broadcast station 308. FIG. 4 shows screen 400, which represents the screen seen by the user when the enhanced television program is being viewed in the conventional, non-interactive manner. At this point, the broadcast image fills substantially all of screen 400.

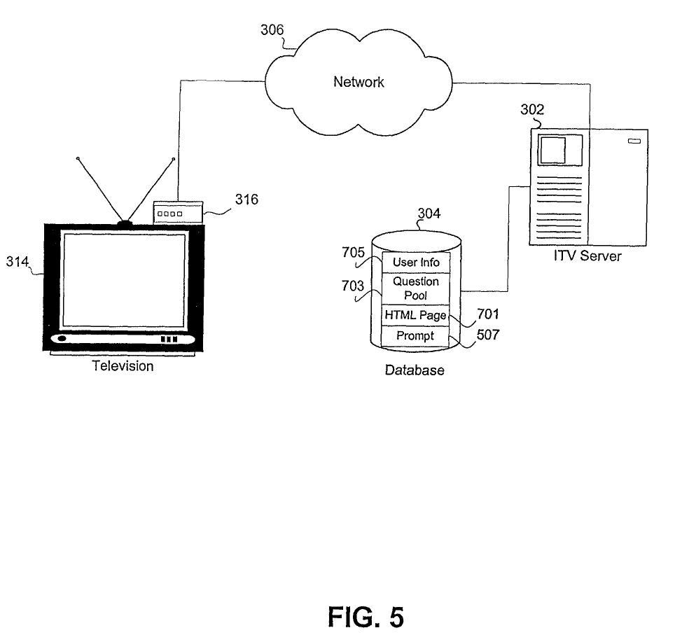

As discussed above, at some point in the broadcast, for example, at the beginning of the broadcast and/or at selected intervals throughout the broadcast, a prompting event in the broadcast stream, for example a prompting trigger, will be detected by STB 316. In one embodiment, a URL contained within the trigger may be interpreted as the Internet address where interactive content is located, and other code within the trigger may be interpreted to determine what functionality is being requested. As shown in FIG. 5, in the present example, the Internet address represented by the URL corresponds to ITV server 302 and the functionality being requested is contained in content 507, which is located in database 304.

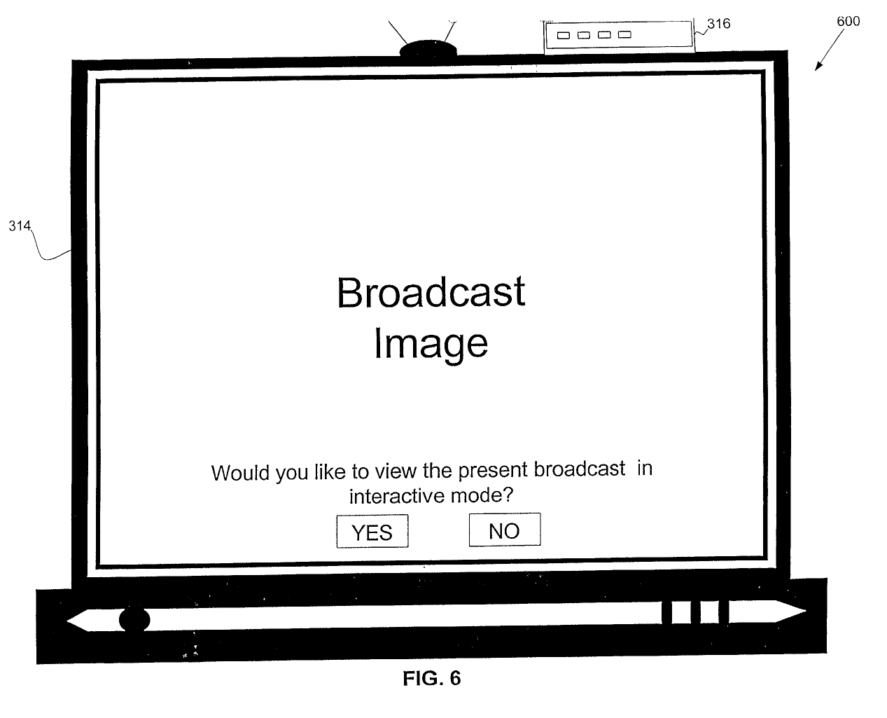

Thus, as shown in FIG. 5, the STB 316 will connect to ITV server 302 through network 306. ITV server 302 will determine that the requested content is content 507 and will access database 304. ITV server 302 will then transfer content 507 to STB 316. In one embodiment, content 507 comprises HTML code that displays a prompt on the screen of television 314 asking whether the user would like to view the program in interactive mode, as shown in FIG. 6. In other embodiments, a textual prompt may be contained within the trigger itself. Thus, in that embodiment, a connection to the network may not be initiated until the user selects a displayed option to view a program interactively. The user is provided with selectable operators with which to make a selection. The operators may comprise user-selectable icons or other indicia displayed on the user's television 314. Alternatively, or in addition, the operators may comprise user-operated hardware switches on the television 314, STB 316, remote control device, wireless keyboard mouse device, or any other suitable selection device.

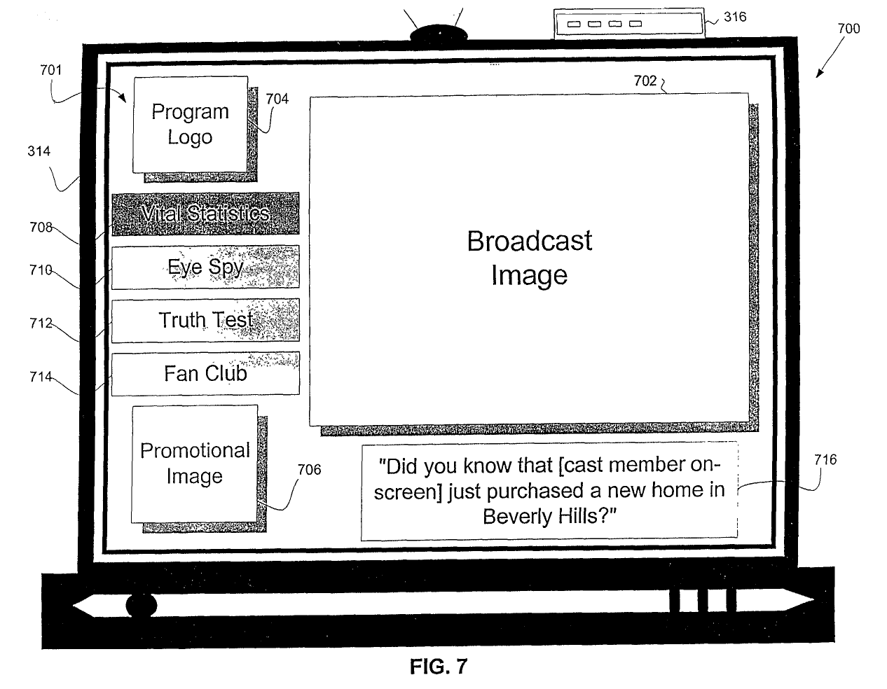

As discussed above, if the user selects “NO,” the user will continue to view the program in the conventional, non-interactive manner. In some embodiments, if the user does not input a response, then the prompt will disappear after a pre-determined time interval. However, if the user selects “YES,” interactive content will be provided that alters the screen of television 314 as shown in FIG. 7.

FIG. 7 shows interactive screen 700, according to one embodiment of the invention. In this embodiment, interactive screen 700 comprises an HTML page 701 similar to one that would be displayed on a computer screen connected to the World Wide Web. Broadcast image 702 now occupies only a portion of interactive screen 700. Within broadcast image 702, the broadcast program will continue to be viewable by the user in a reduced form on HTML page 701. JavaScript code associated with the HTML page provides interactivity to the HTML page by providing, for example, user-selectable operators, forms in which data may be entered by the user, and other functions that are normally performed on World Wide Web HTML pages.

In one embodiment, the software code for the HTML page shown on interactive screen 700 is located in database 304, as shown in FIG. 5. Thus, when the user selects interactive viewing, HTML page 701 is downloaded to STB 316. In other embodiments, the HTML page 701 may already reside in local memory, for example, in a local memory contained within STB 316, possibly as the result of an earlier download. Further HTML pages may be accessed locally or remotely at various times during the program, depending on the particular functionality required.

Besides broadcast image 702, HTML page 701 comprises program logo 704, which may be a graphic image, text, streaming video, or a combination thereof, which may be representative of the program currently being viewed. In addition, promotional image 706 may contain graphics, text, streaming video, or a combination thereof, which promotes various things including, but not limited to, the program currently being viewed, certain cast members, products, upcoming events, and other programs. User-selectable operators 708 through 714 may be selected by the user to provide particular interactive features that may vary from program to program and from time to time within the same program. The area surrounded by broken line 716 represents a user interaction area. User interaction area 716 is an area of HTML page 701 that provides interactive functions, including, but not limited to, questions presented to the user, user-selectable graphics and text-based operators for selecting responses, and forms that may be completed by the user.

In other embodiments, the elements contained in HTML page 701, as well as the manner in which they are presented on the screen, may be different than shown in FIG. 7. For example, the broadcast image may retain its original size and the interactive content may be overlaid on top of the broadcast image. In addition, different interactive operators and features, other than the ones shown in FIG. 7, may be included in different embodiments of the invention.

Furthermore, embodiments are disclosed herein whereby triggers are synchronized with segments of the program content to activate the interactive features of interactive screen 700. However, in other embodiments, time markers may be used for synchronization instead of, or in addition to, the content of the program. For example, in one embodiment, interactive content may be synchronized using an absolute time interval based on the start of the program, or in other embodiments, based on a relative time interval from a particular segment in the program. Thus, for example, the user may be alerted that only a certain amount of time remains in the program or that another program will be airing at a particular time. The user may then be offered an opportunity to request that the user be reminded again about the other program after a certain interval. In still other embodiments, the interactive content may be synchronized with the actual time of day.

### User Interaction

As discussed above, in one embodiment, the triggers that activate the interactive features of interactive screen 700 are synchronized with segments of the program content. Thus, the interactive content may be interrelated to the scene (segment) that is presently being displayed on interactive screen 700. This synchronization with a segment of the program content is used, in one embodiment, to provide content-related facts and other types of information to the user, as described below.

When the “Vital Statistics” operator 708 is selected, as represented in FIG. 7 by the darker shading of operator 708, corresponding triggers that have been inserted in the program will initiate interactive content that is synchronized to related scenes (segments) in the program. Thus, facts and information about a cast member currently shown on-screen may be displayed to the user. For example, as shown in FIG. 7, the following statement may be displayed in user interaction area 716: “Did you know that [cast member on-screen] just purchased a new home in Beverly Hills?” The placement in the program of the trigger that initiates the interactive content that generates this statement may be synchronized with the scene (segment) where the particular cast member is shown.

As another example, in the middle of a car chase scene involving a particular make of car, the following statement may be displayed in user interaction area 716: “Did you know that [make of car involved in chase] can reach speeds of 120 miles per hour?” As yet another example, facts and information about a cast member's clothes may be synchronized with a scene (segment) in which the cast member appears wearing those clothes and the following statement may be displayed in user interaction area 716: “Did you know that [the clothes currently shown] were designed by [designer name]?”

In some embodiments, the user may choose the type of facts and information that will be displayed. For example, the user may choose facts and information about the music played on the program. The user may also choose facts and information about particular cast members or about particular places shown in the program.

In addition to facts and information, triggers may be used to synchronize character insights with the appearance of that character on-screen. Thus, the history of a particular character's exploits on past episodes of the program could be displayed in user interaction area 716 in sync with that character's first appearance in the current episode. In addition, details about the creator of a special effect and/or the manner in which the special effect was created may be synchronized with that special effect on-screen. As an example, as an explosion occurs on-screen, the following statement may be displayed in user interaction area 716: “John Smith, special effects master, created the explosion just seen by [description of process].”

Facts or other information may be presented in a question and answer format. As an example, during a car chase scene, a first trigger may present the question in the user interaction area 716 “What model car is being chased?”. After a predetermined time interval, another trigger could provide the answer. This second trigger may, for example, be synchronized with a scene (segment) in which the make of the car is displayed in a close-up. Further, in addition to trivia and other factual information, the user may be presented with humorous comments or observations related to a particular segment in the program.

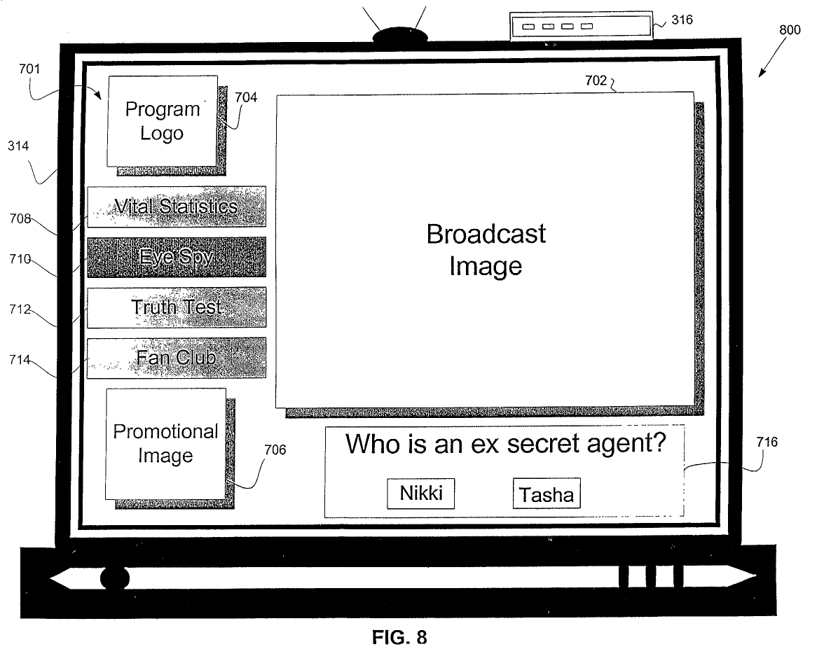

In another embodiment, further enhancement to the user's interactive experience is provided by the presentation to the user of questions related to content that is currently being viewed on-screen. The interactive content which comprises the questions may be synchronized to scenes (segments) in the program to which the question relates. Thus, in one embodiment, the user may select the “Eye Spy” operator 710, as represented in FIG. 8 by the darker shading of operator 710, to initiate this feature. When operator 710 is selected, corresponding triggers that have been inserted in the program will initiate the display of questions that are synchronized to related scenes (segments) in the program.

As shown in FIG. 8, questions related to what is currently being viewed on-screen are presented to the user in user interaction area 716. Thus, as two particular cast members are shown on-screen, the question: “Who is an ex secret agent?” may appear along with choices corresponding to the two cast members currently shown on-screen. The user may then select amongst the choices presented. The user may be presented with feedback to their answers in the form of graphics and/or text which may, for example, tell them if they are correct or, if not, provide them with the correct response. The user may have a pre-determined time interval in which to answer. If the user does not answer within that interval, the correct response may be automatically displayed.

The user may also be asked about events in past episodes of a program that are related to what is currently being shown or to predict what may happen next based on what is occurring presently. For example, the user might be queried: “Do you think she will shoot him?” The user may be provided with a sufficient time to answer before the event occurs.

In some embodiments, a single pre-determined question corresponding to a particular segment in the program will be provided to all users. In other embodiments, questions may be selected from a pool of questions. As an example, question pool 703, which may comprise a large number of questions, is stored in database 304, as shown in FIG. 5. The determination of which question from pool 703 to display may be made pseudo-randomly, for example, by software. The determination may also be made, in some embodiments, based on the user's past performance on questions. For example, if a user has answered previous questions correctly, the subsequent questions may be chosen based on increasing difficulty. Furthermore, in other embodiments the questions may be based on user preferences. For example, if the user has demonstrated an interest in a particular cast member, questions related to that cast member may be displayed. Information about user preferences and past performance may be collected and periodically uploaded to ITV server 302 and stored in database 304.

In addition, as discussed above, selected triggers may be inserted at various cable head ends or other video delivery facilities. Different triggers corresponding to different interactive content may be inserted at different head ends based on, for example, marketing decisions as to the type of content or categories of information that are desired in a particular geographic area, demographics of the geographic area, or a particular user's viewing preferences determined from past viewing habits. In some embodiments, the user may be able to choose amongst different versions of the interactive content, for example, based on appropriateness for a particular age group.

In another embodiment, a user's enjoyment of a particular program may be further enhanced by awarding points or other rewards based on certain actions. For example, points may be awarded to a user for each correct answer to displayed questions. The user's point total may be displayed on HTML page 701 either continuously or periodically. In one embodiment, each question would be worth the same number of points. In other embodiments, point values could be proportional to the difficulty of the question. The point value for each question may be displayed next to the question on-screen. In some embodiments, points may be deducted for wrong answers.

In one embodiment, the accumulation of points would result in a user progressing through a ranking system related to the particular program. For example, if the program is about spying, the user may progress through ranks ranging from “novice spy,” to “master spy.” In other embodiments, points may be redeemed for items such as merchandise related to the program. In yet other embodiments where user participation is based on a pay-per-play model, points may be redeemed for additional plays.

Furthermore, in other embodiments, bonus points may be hidden in certain interactive content such that only users who activate that content will receive those points. In addition, points may be awarded simply for viewing the program once, viewing the program frequently, or for viewing particular interactive portions of the program. The user's accumulated point totals may periodically be uploaded and stored in user information 705 in database 304.

Additional operators may provide additional interactive functionality to the HTML page. As an example, in one embodiment a “Truth Test” operator 712, as shown in FIG. 7, may be selected by the user. The interactive functionality activated by selection of this operator may include the presentation of “true or false” questions to the user that are synchronized to a particular segment in the program. For example, the following statement might be displayed to users when a particular cast member is on-screen: “[cast member] was once a doctor.” Based on their knowledge of the cast member, the user may then select either a “true” or “false” option on the HTML page.

In other embodiments, a “Fan Club” operator 714, as shown in FIG. 7, may be selected by the user. The interactive functionality activated by selection of this operator may include the presentation to the user of the user's status in a fan club for the program being viewed, as well as other information about the fan club, including, but not limited to, merchandise for sale, upcoming club events, and cast member appearances.

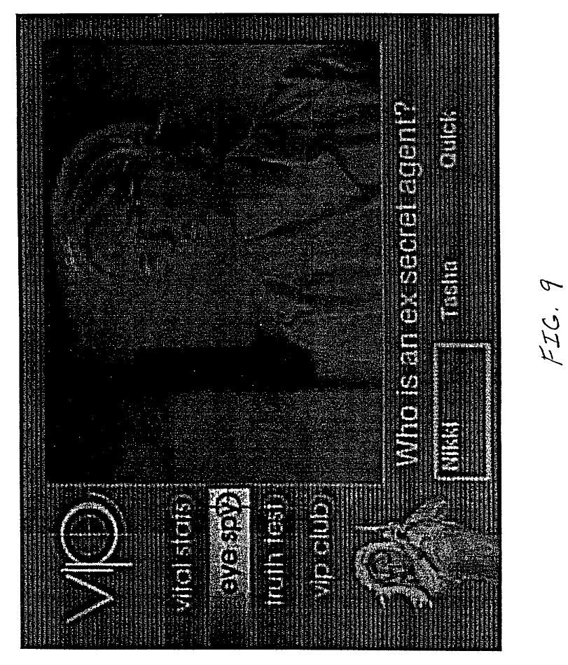

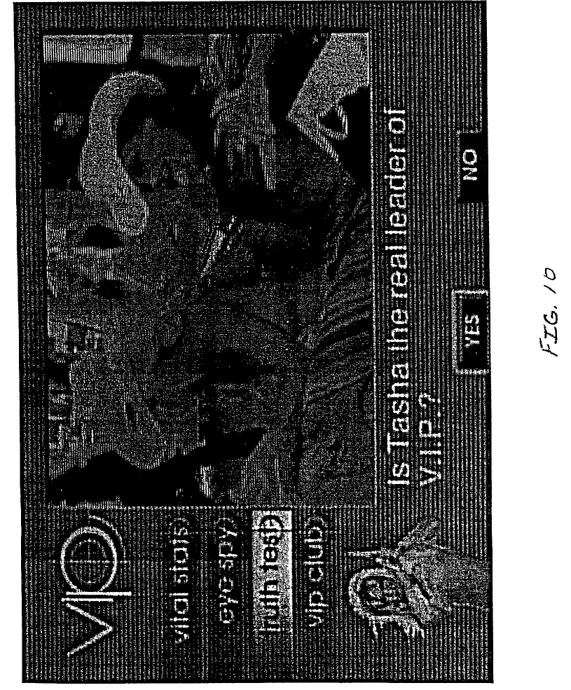

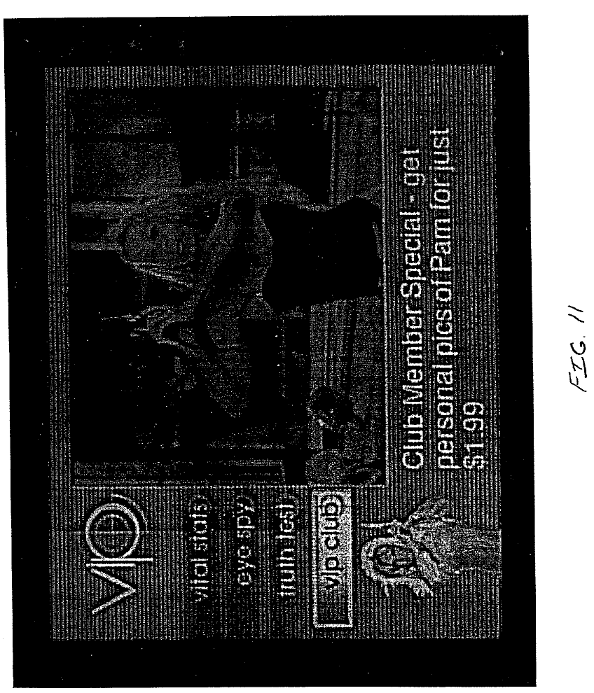

FIGS. 9 through 11 are representative examples of various interactive screens according to embodiments of the present invention discussed above. FIG. 9 is a representative example of a question and answer screen, as discussed above in relation to the “Eye Spy” operator 710. FIG. 10 is a representative example of a “true or false” question and answer screen, as discussed above in relation to “Truth Test” operator 712. FIG. 11 is a representative example of a fan club facts and information screen, as discussed above in relation to “Fan Club” operator 714.

### Advertising

In addition to the normal advertising model of purchasing commercial time to display their products during breaks in the program, embodiments of the present invention offer advertisers an opportunity to display their products on the HTML page which provides interactive content to the user. As an example, promotional image 706 in FIG. 7 may be a graphic and/or textual advertisement for a particular product. This advertisement may, in some embodiments, be user-selectable and may, when selected, display additional information about the product or take the user to the advertiser's home page on the World Wide Web. Advertisers may be charged different rates for advertisements displayed on the HTML page 701 and for those displayed during commercial breaks in the program.

In addition, the advertiser is offered a unique opportunity to tie products to the program the user is viewing. As an example, if a particular automobile is currently being displayed in the program, a trigger synchronized with that segment in the program may present promotional content that, for example, provides additional information about the automobile to the user on portions of the HTML page 701, including, but not limited to graphics, streaming video, and textual information. In addition, a select-to-buy operator or icon may be displayed that may expedite the purchase of an automobile or other product.

As another example, if the cast member is currently drinking a particular beverage on-screen, a trigger that has been inserted at that segment in the program may initiate interactive content that displays the statement: “[cast member] drinks [product], shouldn't you?” As a further example, a manufacturer of clothes may display advertisements on the HTML page 701 synchronized to scenes (segments) in the program when those clothes are being worn by cast members and pointing out that fact. As yet another example, a music company may synchronize advertisements to a segment in the program when a particular piece of music is being played. Thus, at that point in the program the following statement may appear on HTML page 701: “The music you are listening to now is [title], by [artist]. If you would like to purchase this music, select the hyperlink for our Website.”

Various embodiments of the present invention may include one or more of the features, pages, displays, and functions described above. One example embodiment includes all the features, pages, displays, and functions described above.

Therefore, systems and methods for broadcast-synced interactive content interrelated to segments of broadcast content have been described. In one embodiment, an HTML page is displayed to the user on a television screen that also comprises a reduced broadcast image as a portion of the screen. Facts and information that is synchronized to and interrelated with a particular segment in the program is displayed to the user on the HTML page. Although an HTML page was used to display the interactive content in the described embodiments, any suitable software language or protocol for displaying interactive content may be used, including, but not limited to, DHTML, Java, VRML, and CSS.

Embodiments of the present invention further provide functionality within the HTML page that allows the user to select the type of interactive content to be viewed. Thus, the user may view questions that are synchronized to and interrelated with a segment of the content without user input, or may actively input responses to the questions. User responses to questions may be scored or un-scored and may be a basis for earning points or other rewards.

Further embodiments of the present invention allow an advertiser to advantageously synchronize advertisement of products to particular segments of the program where those products are shown and thus advantageously tie products to a particular program.

Thus, it can be seen from the above examples that the user is presented with an enhanced interactive experience that is likely to result in increased attention to and enjoyment of the program being viewed. Various interactive content is presented to the user. The user assumes a more active role vis-a-vis the program being viewed. The interactive content may be activated by various triggers that have been inserted into the broadcast stream either prior to broadcast from a television broadcast station or at various points along the broadcast path.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed.

In addition, although example embodiments described herein are directed to an analog interactive television system that employs an ATVEF standard for delivery of interactive content, including the use of ATVEF triggers, it will be appreciated by those skilled in the art that the teaching of the present invention may be applied to other systems. In fact, any signaling system for providing interactive content is within the teachings of the present invention, without departing from the scope and spirit of the present invention.

Having disclosed exemplary embodiments and the best mode, modifications and variations may be made to the disclosed embodiments while remaining within the scope of the invention as defined by the following claims. what is claimed is:

1. A system for providing interactive content to a user, said system comprising:
a user reception device for the reception of broadcast signals;
a video display associated with the user reception device for displaying a user-perceptible form of the broadcast signals to the user;
a decoding device communicating with the user reception device, the decoding device being programmed to execute an interactive program written for the broadcast content;
a server network device communicating with the decoding device, the server network device being programmed to download segments of the interactive program to the decoding device;
a communication device communicating with the decoding device and with the server network device; and
a memory system communicating with the server network device and the decoding device, the memory system storing segments of the interactive program;
wherein the interactive content is synchronized to segments of the broadcast content which are interrelated to the interactive content.

2. The system recited in claim 1, wherein the interactive program written for the broadcast content comprises HTML pages, the HTML pages comprising the interactive content, the HTML pages being displayed to the user on the video display.

3. The system recited in claim 2, wherein the interactive program further comprises JavaScript code associated with the HTML pages, the JavaScript code providing interactive functionality within the HTML pages.

4. The system recited in claim 3, wherein the provided interactive functionality comprises user-selectable operators for selecting different interactive functions.

5. The system recited in claim 2, wherein the HTML pages further comprise the broadcast content.

6. The system recited in claim 1, wherein the interactive content is synchronized to segments of the broadcast content by events within the broadcast content.

7. The system recited in claim 6, wherein the events within the broadcast content are triggers inserted in the broadcast content.

8. The system recited in claim 6, wherein the events within the broadcast content are time markers.

9. The system recited in claim 7, wherein the triggers are inserted at pre-determined segments within the broadcast content and activate segments of the interactive program that are interrelated to the broadcast content being presented to the user during the pre-determined segments.

10. The system recited in claim 7, wherein the triggers comprise a URL, the URL comprising an Internet address.

11. The system recited in claim 9, wherein the segments of the interactive program provide character insights to the user, the character insights being interrelated with the broadcast content being presented to the user during the predetermined segment of the broadcast.

12. The system recited in claim 9, wherein the segments of the interactive program provide at least one of comments and observations to the user, the at least one of comments and observations being interrelated with the broadcast content being presented to the user during the pre-determined segment of the broadcast.

13. The system recited in claim 9, wherein the segments of the interactive program provide the user's status in a fan club, the fan club being interrelated to the broadcast content.

14. The system recited in claim 9, wherein the segments of the interactive program provide an opportunity for the user to predict what will happen at a later time in the program.

15. The system recited in claim 9, wherein the segments of the interactive program provide questions to the user about past events in a program.

16. The system recited in claim 9, wherein the segments of the interactive program provide facts and information to the user, the facts and information being interrelated with the broadcast content being presented to the user during the pre-determined segment of the broadcast.

17. The system recited in claim 16, wherein the facts and information are provided to the user in a question and answer format, the answer being displayed automatically a pre-determined time interval after the question is displayed.

18. The system recited in claim 16, wherein the facts and information are provided to the user in a question and answer format, the user inputting an answer in response to a displayed question.

19. The system recited in claim 18, wherein the user is provided with on-screen feedback about the user's answer.

20. The system recited in claim 16, wherein the facts and information are provided to the user in a “true or false” question format, the user inputting an answer in response to a displayed question.

21. The system recited in claim 18, wherein rewards are given to users who answer the displayed question correctly.

22. The system recited in claim 21, wherein the rewards comprise a number of points.

23. The system recited in claim 22, wherein the same number of points is earned for each correct answer.

24. The system recited in claim 22, wherein the number of points is directly proportional to the difficulty of the question.

25. The system recited in claim 22, wherein a number of points is deducted for each incorrect answer.

26. The system recited in claim 22, wherein the points are continuously displayed on the HTML page.

27. The system recited in claim 22, wherein the points are redeemable for merchandise.

28. The system recited in claim 22, wherein the points are redeemable for additional plays.

29. The system recited in claim 22, wherein the user is ranked according to the number of points accumulated by the user.

30. The system recited in claim 22, wherein bonus points are hidden in particular interactive content such that only users who activate the particular interactive content receive the bonus points.

31. The system recited in claim 18, wherein a single predetermined question corresponding to a particular trigger in the program content is provided to all users.

32. The system recited in claim 18, wherein the questions are chosen from a pool of questions, the pool of questions being stored in the memory system.

33. The system recited in claim 18, wherein the questions are chosen pseudo-randomly.

34. The system recited in claim 18, wherein the questions are chosen based on the user's past performance.

35. The system recited in claim 18, wherein the questions are chosen based on the user's preferences.

36. The system recited in claim 1, wherein different versions of the interactive content may be selected by the user.

37. The system recited in claim 1, wherein the user reception device is a television.

38. The system recited in claim 1, wherein the video display is a television screen.

39. The system recited in claim 1, wherein the decoding device is a set-top box.

40. The system recited in claim 1, wherein the communication device is a cable modem.

41. The system recited in claim 1, wherein the memory system comprises a database associated with the server network device.

42. The system recited in claim 1, wherein the decoding device further comprises a memory for storing interactive programs and user information.

43. A method for providing interactive content to a user, said method comprising:
programming a processor to provide interactive content, the interactive content being interrelated to pre-determined broadcast content;
inserting an event within the broadcast content, the event being inserted in the broadcast content at a pre-determined segment, the pre-determined segment being interrelated to pre-determined interactive content;
receiving a broadcast signal, the broadcast signal comprising the broadcast content;
decoding the event as it is encountered in the broadcast content, the decoded event activating a segment of the interactive content; and
displaying both the broadcast content and the activated segment of the interactive content to the user on a video display;
wherein the event activates a segment of the interactive content that is interrelated to the segment of the broadcast content in which the event is inserted.

44. The method recited in claim 43, wherein programming a processor to provide interactive content comprises programming a processor to provide interactive content comprising HTML pages, the HTML pages being displayed on the video display.

45. The method recited in claim 44, wherein programming a processor to provide interactive content further comprises programming the processor to provide interactive content which comprises JavaScript code associated with the HTML pages, the JavaScript code providing interactive functionality to the HTML pages.

46. The method recited in claim 43, wherein programming a processor to provide interactive content comprises programming a processor to provide interactive content comprising HTML pages, the HTML pages further comprising the broadcast content.

47. The method recited in claim 43, wherein inserting an event within the broadcast content comprises inserting a trigger within the broadcast content.

48. The method recited in claim 43, wherein receiving a broadcast signal comprises receiving the broadcast signal transmitted by a television broadcast station.

49. The method recited in claim 43, wherein receiving a broadcast signal comprises receiving the broadcast signal transmitted by a cable provider.

50. The method recited in claim 43, wherein receiving a broadcast signal comprises receiving the broadcast signal transmitted by a satellite provider.

51. The method recited in claim 43, wherein decoding the event as it is encountered in the broadcast content comprises programming a processor within a set-top box to decode a trigger inserted in the broadcast content.

52. The method recited in claim 43, wherein displaying both the broadcast content and the interrelated interactive content to the user on a video display comprises displaying the broadcast content in a reduced form within an HTML page on the video screen.

53. The method recited in claim 52, wherein displaying both the broadcast content and the interrelated interactive content to the user on a video display further comprises displaying user-selectable operators, the user-selectable operators enabling a user to select different interactive functions.

54. A method for selling advertising time during a broadcast program by associating advertised products and services with broadcast content, the method comprising:
providing advertising content, the advertising content being interrelated to pre-determined broadcast content;
inserting an event within the broadcast content, the event being inserted in a pre-determined segment of the broadcast content, the pre-determined segment of the broadcast content being interrelated to pre-determined advertising content;
decoding the event as it is encountered in the broadcast content, the decoded event activating the pre-determined advertising content;
displaying both the broadcast content and the activated pre-determined advertising content to a user on a video display;
receiving a fee for displaying the activated pre-determined advertising content to the user on the video display.

55. The method recited in claim 54, wherein providing advertising content comprises programming a processor to provide advertising content within an HTML page, the HTML page being displayed on the video display.

56. The method recited in claim 54, wherein inserting an event within the broadcast content comprises inserting a trigger within the broadcast content.

57. The method recited in claim 54, wherein decoding the event as it is encountered in the broadcast content comprises programming a processor within a set-top box to decode a trigger inserted in the broadcast content.

58. The method recited in claim 54, wherein the advertising content comprises user-selectable operators, the user-selectable operators providing interactive functions.

59. The method recited in claim 58, wherein the interactive functions comprise at least one of a hyperlink to a promoter's Website, product-related graphics, product-related textual information, a select-to-buy operator, and streaming video.

60. A system for providing to a user interactive enabling system interactive content that is synchronized to broadcast content, the system comprising:
an insertion device for inserting events into broadcast content;
a transmission device for transmitting the broadcast content to the user interactive enabling system;
a server network device communicating with the user interactive enabling system; and
a memory system communicating with the server network device, the memory system storing the interactive content;
wherein the inserted events are synchronized to particular segments of the broadcast content and activate particular segments of the interactive content interrelated to the particular segments of the broadcast content such that both the broadcast content and the interrelated interactive content are displayed on the user interactive enabling system.

61. The system recited in claim 60, wherein the interactive content comprises HTML pages, the HTML pages being displayed to the user.

62. The system recited in claim 61, wherein the interactive content further comprises JavaScript code associated with the HTML pages, the JavaScript code providing interactive functionality within the HTML pages.

63. The system recited in claim 62, wherein the provided interactive functionality comprises user-selectable operators for selecting different interactive functions.

64. The system recited in claim 61, wherein the HTML pages further comprise the broadcast content.

65. The system recited in claim 60, wherein the events inserted in the broadcast content are triggers.

66. The system recited in claim 60, wherein the events inserted in the broadcast content are time markers.

67. The system recited in claim 65, wherein the triggers comprise a URL, the URL comprising an Internet address.

68. The system recited in claim 60, wherein the transmission device is a television broadcast station transmitter.

69. The system recited in claim 60, wherein the transmission device is a transmission cable.

70. The system recited in claim 60, wherein the transmission device is a satellite transmitter.

71. The system recited in claim 1, wherein the memory system comprises a database associated with the server network device.

72. A user interactive enabling system for receiving interactive content that is synchronized to broadcast content, the system comprising:
a user reception device for receiving broadcast signals, the broadcast signals comprising broadcast content;
a video display associated with the user reception device for displaying a user-perceptible form of the broadcast content to the user; and
a decoding device communicating with the user reception device, the decoding device being programmed to decode events inserted in particular segments of the broadcast content;
wherein the inserted events are synchronized to particular segments of the broadcast content and activate particular segments of the interactive content interrelated to the particular segments of the broadcast content such that both the broadcast content and the interrelated interactive content are displayed on the video display.

73. The user interactive enabling system recited in claim 72, further comprising a communication device for communicating over a network.

74. The user interactive enabling system recited in claim 73, wherein the server network device downloads the interactive content to the decoding device.

75. The user interactive enabling system recited in claim 72, wherein the user reception device is a television.

76. The user interactive enabling system recited in claim 72, wherein the video display is a television screen.

77. The user interactive enabling system recited in claim 72, wherein the decoding device is a set-top box.

78. The user interactive enabling system recited in claim 73, wherein the communication device is a cable modem.

79. The user interactive enabling system recited in claim 72, wherein the decoding device further comprises a memory for storing interactive content and user information.
